(19) United States
(12) Patent Application Publication
(10) Pub. No.: US 2006/0049949 A1
(43) Pub. Date: Mar. 9, 2006

(54) RFID Potted Mounting Hole, RFID Mounting Clip and Associated Meat Hook Assembly

(75) Inventors: Jeffry W. Jurs, Bartlett, IL (US); Abel Rivera, Plainfield, IL (US); Richard A. Newman, Geneva, IL (US)

Correspondence Address: PATENTS AND LICENSING LLC;DANIEL W. JUFFERNBRUCH, 28 BARRINGTON BOURNE, BARRINGTON, IL, 60010-9605, US

(73) Assignee: OMRON ELECTRONICS LLC, Schaumburg, IL (US)

(21) Appl. No.: 10/711,299

(22) Filed: Sep. 9, 2004

(51) Int. Cl. G08B 13/14; G06K 19/06

(52) U.S. Cl. 340/572.8; 235/492

(57) ABSTRACT

An epoxy potting compound holds a radiofrequency identification (RFID) tag in a recessed hole of an assembly. Sidewalls of the recessed hole have a characteristic which securely holds the epoxy potting compound. In various embodiments the sidewalls can be undercut at an angle or can be surface treated such as by knurling to hold the RFID tag and epoxy potting compound more securely in the harsh environment of a meat hook. A mounting clip with fingers and an aperture can instead be used to securely hold the RFID tag onto a meat hook assembly. Flanges on opposing sides of this mounting clip are shaped to conform to sides of a main body of the meat hook. An aperture in an upper flange makes room for the axle of its pulley wheel.

### BACKGROUND OF THE INVENTION

1. Technical Field

The present invention relates to radio frequency identification (RFID) tag mountings and, more particularly, relates to the mountings of RFID tags with potting and clips on assemblies such as meat hooks.

2. Description of the Related Art

RFID tags are commonly used to track merchandise and commodities through distribution networks and processes. One important application for a RFID tag is tracking of meat carcasses. To track meat carcasses, the meat packing industry typically places and RFID tag on a meat hook assembly.

A meat packing environment subjects an RFID tag to harsh treatment. Besides rough handling and movement, harsh soaps and chemicals are used during cleanup. Temperature extremes are common. Given the incidence of mad cow disease and other hazards, reliable tracking of carcasses is becoming increasingly important. In order to reliably track a carcass and avoid the expense of repair should a mount fail, an RFID tag needs to be securely mounted to a meat hook assembly.

What is needed is a way of securely mounting an RFID tag to a meat hook that can survive rough handling, harsh chemicals and temperature extremes while still maintaining adequate electrical performance.

### SUMMARY OF THE INVENTION

It is an object of the present inventions to securely hold a RFID tag in a recessed hole of an assembly.

It is another object of the present inventions to securely hold a RFID tag on a meat hook.

It is a further object of the present inventions to configure the side walls of a recessed hole to securely hold a potting compound for an RFID tag.

It is an additional further object of the present inventions to use an adhesive to hold an RFID tag in a recessed hole of an assembly before potting the hole.

It is another further object of the present inventions to place a spacer in a recessed hole that holds an RFID tag.

Further it is an object of the present inventions to use a potting compound having a low loss electromagnetic characteristic at the operation frequency of the RFID tag.

An object of the present inventions is to provide a mounting clip for securely holding an RFID tag on a meat hook assembly.

A further object of the present inventions is to provide a mounting clip with fingers and an aperture to securely hold the RFID tag onto an assembly.

Another object of the present inventions is to provide a mounting clip with flanges on opposing sides shaped to conform to sides of a main body of an assembly.

An epoxy potting compound holds a radio frequency identification (RFID) tag in a recessed hole of an assembly. Sidewalls of the recessed hole have a characteristic which securely holds the epoxy potting compound. In various embodiments the sidewalls can be undercut at an angle or can be surface treated such as by knurling to hold the RFID tag and epoxy potting compound more securely in the harsh environment of a meat hook.

A mounting clip with fingers and an aperture can instead be used to securely hold the RFID tag onto a meat hook assembly. Flanges on opposing sides of this mounting clip are shaped to conform to sides of a main body of the meat hook. An aperture in an upper flange makes room for the axle of its pulley wheel.

The details of the preferred embodiments of the invention will be readily understood from the following detailed description when read in conjunction with the accompanying drawings wherein:

### BRIEF DESCRIPTION OF THE DRAWINGS

FIG. 1 illustrates an isometric view of a potted radio frequency identification (RFID) tag on a meat hook assembly according to an embodiment of the present inventions;

FIG. 2 illustrates a cutaway view at the side of the potted RFID tag on a meat hook assembly of FIG. 1;

FIG. 3 illustrates a cutaway view of alternative embodiments of a potted RFID tag according to the present inventions;

FIG. 4 illustrates a cutaway view of further alternative embodiments of a potted RFID tag according to the present inventions;

FIGS. 5 and 6 illustrate isometric views of an embodiment of an RFID tag clip according to the present inventions; and

FIG. 7 illustrates a side view of an RFID tag clip on a meat hook assembly according to an embodiment of the present inventions.

### DETAILED DESCRIPTION OF THE PREFERRED EMBODIMENTS

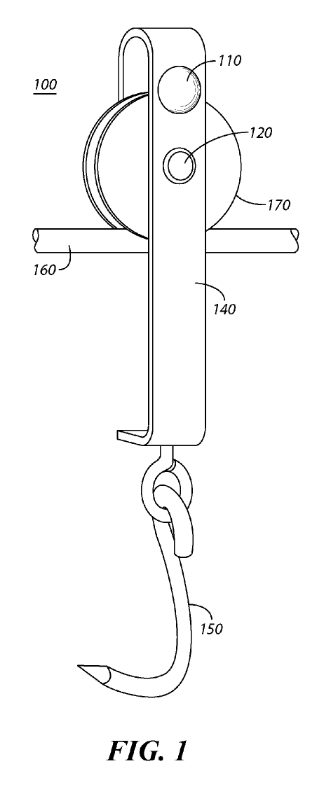

FIG. 1 illustrates an isometric view of a meat hook assembly 100 having an epoxy potting compound 110 holding a radiofrequency identification (RFID) tag. A recessed hole in a main body 140 of the meat hook contains the RFID tag. The epoxy potting compound 110 fills the hole and holds the tag. According to a preferred embodiment, the sidewalls of the hole have a characteristic which securely holds the epoxy potting compound 110. For example, the sidewalls are undercut at an angle so that the bottom of the hole has a wider diameter then the top of the hole. The undercut sidewalls therefore better hold the epoxy potting compound 110. Holding the RFID tag and epoxy potting compound 110 more securely can be important particularly in a harsh environment such as that of a meat hook.

A hook 150 is connected via a steel eye to the main body 140 near a bottom of the meat hook assembly 100. A pulley wheel 170 rests the meat hook assembly on a guide wire 160. The pulley wheel 170 is rotatably coupled to the main body 140 near a top of the meat hook assembly 100, below the recess 110 and above the hook 150. The main body 140 of the meat hook is made of metal stock, preferably steel, and bends 180 degrees at the top of the meat hook assembly 100 so that the pulley wheel 170 is twice rotatably coupled to the metal stock at each of two ends of its axle 120.

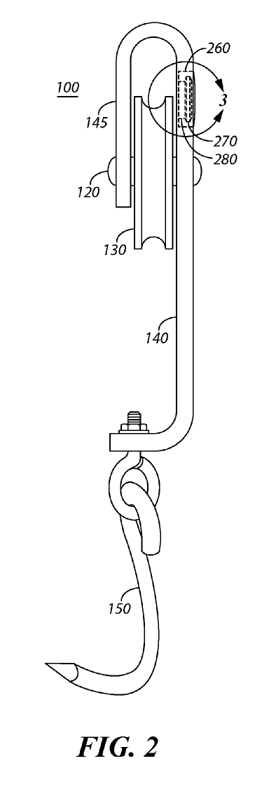

FIG. 2 illustrates a view at the side of the potted RFID tag on a meat hook assembly 100 of FIG. 1. Axle 120 is illustrated connecting the pulley 130 on one side of the main body 140 and another side 145 of the bend in the main body. Pulley 130 and axle 120 holds the hook 150 on the wire guide.

The RFID tag 270 is illustrated in the recessed hole 260. A spacer 280 is disposed between the RFID tag 270 and a bottom of the recessed hole 260. An epoxy potting compound fills the hold and holds the FRID tag 270. The recessed hole 260 has a depth of approximately 0.25 to 0.3 inches (0.635 to 0.762 centimeters) and a diameter of no less than approximately one inch (2.54 centimeters).

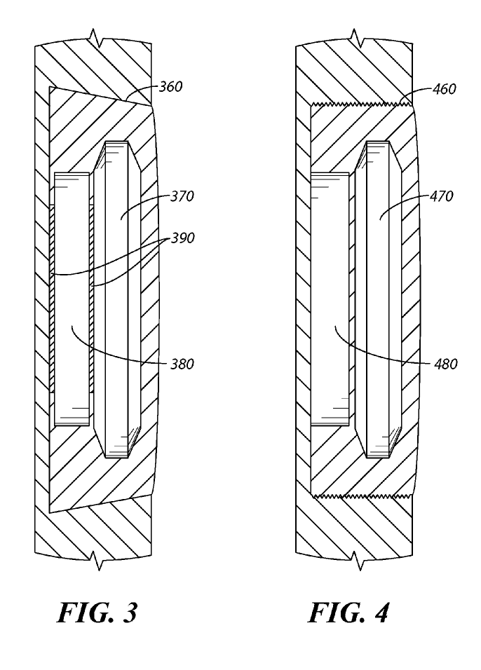

Alternative embodiments of the potted RFID tag are illustrated in greater detail by the cutaway portions of FIGS. 3 and 4.

FIG. 3 illustrates a cutaway view of an alterative embodiment of a potted RFID tag. RFID tag 370 is illustrated in the recessed hole 360 with a spacer 380. The RFID tag 370 is preferably the V700 series V700-D13P31 tag by Omron Electronics, Schaumburg, Ill. The spacer 380 is preferably made of a polyamide such as nylon 66 of approximately 0.15 to 0.19 inches thick (0.381 to 0.4826 centimeters). Alternatively the spacer 380 can be a closed cell foam. While a coin-shaped RFID tag 370 and spacer 380 is illustrated, other shapes are possible. The spacer 380 is placed between the RFID tag 370 and the main body at least at a bottom of the recessed hole 360. An adhesive is placed at least between the RFID tag 370 and the spacer 380 and between the spacer 380 and at least a bottom of the recessed hole 360. The adhesive 390 holds the RFID tag 370 in place before the epoxy potting is applied to fill the recessed hole.

The adhesive used to hold the closed cell foam is preferably cyanoacrylate commonly known as super glue and manufactured by Permatex or Elmer's Products, Inc. and sold by Elmer's Products, Inc. as Krazy Glue™. Such cyanoacrylate adhesive can also be used with the nylon 66 spacer though it is preferred to use just the epoxy potting compound itself as the adhesive. The adhesive holds the RFID tag 370 in place while the recessed hole 360 is being filled with the epoxy potting compound. Though the adhesive is preferred, it is not necessary.

A preferred epoxy potting compound is Scotch Weld™ Epoxy Adhesive DP110 in gray made by 3M Corporation. The epoxy resin is formed by mixing parts A and B. Part A of the gray Scotch Weld™ Epoxy Adhesive 110 is 60% to 100% of mercaptan terminated polymer—N.J. trade secret registry number 679485-5016P, 10% to 30% of a polyamide resin, 5% to 10% of hydrogenated terphenyl, 1% to 5% of a epoxy resin, 1% to 5% of 2,4,6-[(dimethylamino)methl]phenal, 0.5% to 1.5% of hydrogenated polyphenyls and 0.1% to 1% of carbon black. Part B of the gray Scotch Weld™ Epoxy Adhesive 110 is 70% to 100% of epoxy resin, 10% to 30% of a methacrylate/butadiene/styrene polymer, 5% to 10% of hydrogenated terphenyl, 0.5% to 1.5% of hydrogenated polyphenyls and 0.5% to 1.5% of titanium dioxide.

The electromagnetic properties of the epoxy potting compound depend on the frequency of an RFID tag used. The preferred coin-shaped V700-D13P31 RFID tag has a frequency of 125 kHz. The preferred potting compound has low loss electromagnetic characteristics at the 125 kHz frequency of operation of the RFID tag. The loss factor of the potting material is more important than its dielectric constant because at the 125 kHz frequency the wavelength is too long for the size hole used to act as a waveguide. Only over 500 MHz would it matter, and then a low loss material such as Teflon™ by DuPont would be preferred.

The sidewalls of the recessed hole 360 have a characteristic which securely holds the epoxy potting compound 110. In the embodiment of FIG. 3, the sidewalls are undercut at an angle so that the bottom of the hole has a wider diameter then the top of the hole. The undercut sidewalls therefore better hold the epoxy potting compound 110. A preferred angle is about 5 degrees or no less than about 2 degrees, but any angle sufficient to hold the potting compound should work. The undercut sidewalls of the recessed hole are cut using a vertical end mill with a tapered bit. Holding the RFID tag and epoxy potting compound 110 more securely can be important particularly in a harsh environment.

FIG. 4 illustrates a cutaway view of a further alternative embodiment of a potted RFID tag. RFID tag 470 is illustrated in the recessed hole 460 with a spacer 480. Sidewalls at 460 have a surface treatment sufficient to hold the potting compound. The sidewall surface treatment holds the epoxy potting compound securely within the main body. Holding the potting compound more securely can be important particularly in a harsh environment such as that of a meat hook.

A preferred surface treatment is knurling with a knurling tool. Cross hatching or rough cutting can be made by a roughing end mill in one step with the cutting of hole. Knurling will require in a second step after cutting the hole. Acid etching is an alternative, possible but is slow and cost ineffective. Sandblasting also possible.

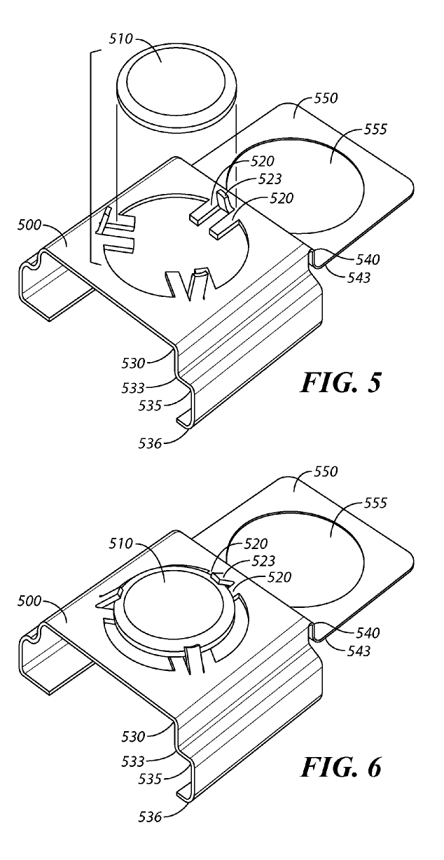

FIGS. 5 and 6 illustrate isometric views of a mounting clip 500 for a RFID tag 510 according to alternative embodiments of the present inventions. The mounting clip 500 has an aperture with a plurality of fingers 520 and 523 for holding the RFID tag 510 within the aperture. Fingers 520 attach to a bottom side of the RFID tag 510 and fingers 523 attach to a top side of the RFID tag 510.

A pair of flanges on opposing sides of the mounting clip 500 is shaped to conform to sides of a main body of the meat hook. Each flange is formed by bends 530, 533, 535 and 536 as illustrated to go around the metal stock of the meat hook approximately ⅜ inches (0.95 centimeters) thick.

An upper flange 550 is formed by illustrated bends 540 and 543. The upper flange 550 has an aperture 555 to make room for the axle of the meat hook pulley wheel.

The mounting clip is metallic and preferably made of stainless steel stock of approximately 1.25 inches (3.175 centimeters) by approximately 2.75 inches (7 centimeters).

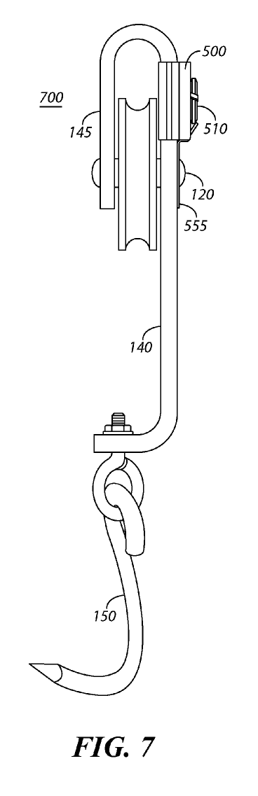

FIG. 7 illustrates a side view of an RFID tag clip 500 of FIGS. 5 and 6 for holding the RFID tag 510 on a meat hook assembly 700. Axle 120 is illustrated connecting a pulley between one side of a main body 140 and another side 145 of a bend in the main body. A pulley on the axle 120 holds the hook 150 on the wire guide. The upper flange 555 of the clip 500 is disposed over the axle 120 of a pulley wheel of the meat hook assembly 700.

Although the invention has been described and illustrated in the above description and drawings, it is understood that this description is by example only, and that numerous changes and modifications can be made by those skilled in the art without departing from the true spirit and scope of the invention. Although the examples in the drawings depict only example constructions and embodiments, alternate embodiments are available given the teachings of the present patent disclosure. Use of the potted hole and clip is not limited to meat hooks and can be deployed in multiple RFID application environments.

What is claimed is:

1. A meat hook assembly, comprising:
a main body having a recess formed therein;
a radiofrequency identification tag within the recess; and
a potting compound within the recess for securing the radiofrequency identification tag;
wherein the recess has sidewalls having characteristics sufficient to hold the potting compound.

2. A meat hook assembly according to claim 1,
wherein the sidewalls sufficiently taper outward near a bottom of the recess to hold the potting compound.

3. A meat hook assembly according to claim 1,
wherein the sidewalls have a surface treatment sufficient to hold the potting compound.

4. A meat hook assembly according to claim 3,
wherein the surface treatment is knurling.

5. A meat hook assembly according to claim 1, further comprising
a hook fixedly coupled to the main body near a bottom of the meat hook assembly; and
a pulley wheel rotatably coupled to the main body near a top of the meat hook assembly.

6. A meat hook assembly according to claim 5,
wherein the pulley wheel is rotatably coupled to the main body below the recess and above the hook.

7. A meat hook assembly according to claim 5,
wherein the main body comprises metal stock;
wherein the metal stock bends 180 degrees at the top of the meat hook assembly; and
wherein the pulley wheel is twice rotatably coupled to the metal stock at each of two ends of its axis.

8. A meat hook assembly according to claim 1,
wherein the main body comprises metal stock.

9. A meat hook assembly according to claim 1, further comprising
a spacer disposed between the radiofrequency identification tag and the main body; and
an adhesive disposed at least between the radiofrequency identification tag and the spacer and between the spacer and the recess.

10. An assembly, comprising:
main body having a recess formed therein;
a radiofrequency identification tag within the recess;
a potting compound within the recess for securing the radiofrequency identification tag;
wherein the recess has sidewalls having characteristics sufficient to hold the potting compound.

11. An assembly according to claim 10,
wherein the sidewalls sufficiently taper outward near a bottom of the recess to hold the potting compound.

12. An assembly according to claim 10,
wherein the sidewalls of the recess have a surface treatment sufficient to hold the potting compound.

13. An assembly according to claim 13,
wherein the surface treatment is knurling.

14. An assembly according to claim 10,
wherein the main body comprises metal stock; and
wherein the assembly further comprises:
a hook fixedly coupled to the main body near a bottom of the assembly; and
a pulley wheel rotatably coupled to the main body near a top of the assembly.

15. An assembly according to claim 10, further comprising
an adhesive disposed between the radiofrequency identification tag and the main body at least at a bottom of the recess.

16. An assembly according to claim 10, further comprising
a spacer disposed between the radiofrequency identification tag and the main body at least at a bottom of the recess; and
an adhesive disposed at least between the radiofrequency identification tag and the spacer and between the spacer and at least a bottom of the recess.

17. An assembly according to claim 10,
wherein the potting compound has low loss electromagnetic characteristics at a frequency of operation of the radiofrequency identification tag.

18. A mounting clip for mounting a radiofrequency identification tag on a meat hook assembly, the mounting clip comprising:
an aperture;
a plurality of fingers for holding the radiofrequency identification tag within the aperture;
a pair of flanges on opposing sides of the mounting clip shaped to conform to sides of a main body of the meat hook assembly.

19. A mounting clip according to claim 18,
wherein the mounting clip further comprises an upper flange disposed near an axis of a pulley wheel of the meat hook assembly.

20. A mounting clip according to claim 18,
wherein some of the plurality of fingers attach to one side of the radiofrequency identification tag and other of the plurality of fingers attach to another side of the radiofrequency identification tag.
